(19) United States
(12) Patent Application Publication
(10) Pub. No.: US 2007/0057775 A1
(43) Pub. Date: Mar. 15, 2007

(54) Unpredictable alarm clock

(76) Inventors: Mike R. O'Reilly, San Francisco, CA (US); Gregory W. Pronko, San Francisco, CA (US)

Correspondence Address: THE PATENT LAW OFFICE OF FRANK P. BECKING, P. O. BOX 800, PALO ALTO, CA, 94302, US

(21) Appl. No.: 11/223,771

(22) Filed: Sep. 10, 2005

(51) Int. Cl. G08B 25/00

(52) U.S. Cl. 340/309

(57) ABSTRACT

Devices and methods for waking a person from sleep are provided. Embodiments of the subject devices are alarm clocks that have an extensive sound library stored in memory thereof. The sounds of the sound library differ in the nature of their intensity to offer a user variety in experience in order to maintain the effectiveness of the alarm such that its use is not easily tuned-out.

### BACKGROUND OF THE INVENTION

Alarm clocks that activate an audible signal at a selected time and until the signal is stopped user action are well known. Often, these alarm clocks offer the user the choice of either waking to an alarm sound, waking to the radio or, more recently, to the sound of an audio CD. However, over a short period of time, many people grow accustomed to the limited, familiar sounds of their alarm clock. As a user becomes accustomed to the sounds of their alarm clock, the sounds may lose their effectiveness in waking the user up from sleep.

In response to this problem, a variety of techniques have been devised. One system employs two alarms in one clock. The second alarm may serve as a “back-up” so that if the user is not aroused from sleep by the first alarm, then the user may at least be “primed” by the first alarm to finally wake. Still, in the long run this strategy also becomes familiar, and thus, less effective.

Other alarm clocks attempt to overcome the ineffectiveness of audio alarms by stimulating a variety of senses in addition to sound, such as sight, feel, etc. For example, US Patent Publication no. 20040151076 discloses an alarm clock that incorporates an under-the pillow vibrating pad; the Protect911 Sonic Boom™ Alarm Clock from Sonic Alert uses flashing lights (e.g., a household lamp can be plugged into the clock that will flash when the alarm is activated) and a shaking bed vibrator.

There continues to be an interest in devices and methods for waking-up a person from sleep. Of interest are devices with improved efficacy and/or offering more appealing approaches to a user by offering one or more wake-up features providing an aspect of unpredictability.

### SUMMARY OF THE INVENTION

Accordingly, new devices and methods for arousing a person from sleep are provided. The subject invention involves an alarm clock utilizing the effectiveness of wake-up sounds that surprise or are at least unexpected for a user. A highly-effective and more user-friendly system is provided by also including the user with the option of selected the intensity of the upcoming sound from a plurality of groups. Sound intensity groups to choose from may include: serene, standard, and severe. Knowing oneself and relative importance of waking on time the next day, a user may deside that a standard signal will suffice. Otherwise a serve intensity sound may be required. Such an ability to choose among sound types may offer a level of user comfort. Yet, by still offering unexpected sounds in the form of an alarm effectiveness of the system is maintained.

The subject devices are adapted to include an extensive sound library from which a wake-up sound may generated, thereby providing a great deal of customization and flexibility in the type of wake-up sound that is used for a particular wake-up event. Typically these sounds are grouped (at least in terms of user selectability or output) into at least two sound intensity modes or settings (e.g., three or more sound intensity modes) that may be selectable by a user. Each sound intensity mode includes a plethora of sounds (e.g., tens, hundreds, thousands, tens of thousands, etc.).

Sounds may qualify for categorization within a given genere or intensity group as determined by the association the listener makes with the output and/or recorded volume/level. The qualitative concept of “intensity” in this regard is intended to embrace the natural or inherent quality of groups of sounds categorized by their ability to wake people up more quickly vs. more peacefully. Numerous examples are provided below.

The subject invention provides alarm clocks that include a memory device, a sound library of a plurality of sounds of different intensities stored in the memory device, and a selector for selecting from the sound library. The sound library may be edited by the user (e.g., updated or changed by the user). The wake-up sounds may be recorded (e.g., via an audio recorder, or downloaded from an external source communicable with the alarm clock), stored in memory, and made available for use for a wake-up event. In certain embodiments, the alarm clocks are programmable for a plurality of different wake-up protocols (e.g., based on different days of the week, time of day, etc.) wherein different wake-up protocols may have different sound intensities.

The subject invention includes setting a wake-up time in an alarm clock to activate the wake-up sound the set time matches a current time and designating a particular sound intensity mode for the wake-up sound. The sound played may be selected at random from the specific category. However, for a newly downloaded or a large play list, sequential play of sounds may suffice in offering a user with new or unexpected content.

Certainly, one of the most appealing aspects of the invention is that it will always sound “fresh” to a user. The approach taught herein is designed so that a user will be intrigued, amused, or more apt to wake by virtue of a different level of engagement than typically experienced in exposure to alarm sounds. In one embodiment of the invention, the user selects the category or intensity mode of sounds most apt to meet his or her needs, and the particular sound played as an alarm from that category is unexpected. In another variation, both of the intensity and sound may be unexpected. In other words, each of the intensity selection and the sound itself may be (or at least appear) randomized.

The default setting of the device may be to offer an unexpected or random sound from a given user-selected category upon alarm activation. However, an override feature or specific selection mode may also be incorporated in the device that allows the operator to select specific alarm sounds. A user may, after all, develop favorites. Thus, a system is contemplated in which a user may choose not to employ one or more of the features described herein. Likewise, it is contemplated that the subject invention includes systems employing any combination of features taught herein.

The present invention further provides a computer program product comprising a computer readable storage medium having a computer program stored thereon for use with the subject alarm clocks. The program when loaded into a processor of dedicated hardware or a personal computer causes the alarm clock to execute any one or more methods of the present invention. Another computer-readable medium product may comprise unloadable recordings or other information adding to or defining new categories as elaborated upon below or otherwise.

### BRIEF DESCRIPTIONS OF THE DRAWINGS

The figures diagrammatically illustrate aspects of the invention. Of these:

FIG. 1 shows a table of exemplary sound intensity categories and exemplary sounds thereof;

FIG. 2 shows a block diagram of an exemplary embodiment of the subject invention;

FIG. 3 shows a schematic of an exemplary alarm clock of the subject invention;

FIG. 4 shows an exemplary embodiment of a sound intensity selector in the form of a dial that may be included in a subject alarm clock;

FIG. 5 shows an exemplary embodiment of a sound intensity selector in the form of a visual display that may be included in a subject alarm clock; and

FIG. 6 shows another exemplary embodiment of a sound intensity selector in the form of a visual display that may be included in a subject alarm clock and that includes a plurality of user-selectable wake-up parameters.

Variation of the invention from that shown in the figures is contemplated.

### DETAILED DESCRIPTION OF THE INVENTION

The subject invention includes devices and methods for arousing a person from sleep. As noted above, all too often the familiar repeated alarm sounds and radio or CD music offered by conventional alarm clocks tend to become ineffective in arousing a person from sleep. To address this and other issues, the alarm clocks of the subject invention include, in addition to clock circuitry, a stored sound library, thereby substantially increasing the quantity and variety of sounds that may be used for wake-up signals.

The sound library of the subject alarm clocks may include any number of different wake-up sounds. The alarm clocks of the subject invention are adapted to store a far greater number of wake-up sounds than available in conventional alarm clocks.

In certain embodiments, the number of sounds of a sound library stored in a subject alarm clock may be of sufficient number to enable a different wake-up sound to be used every time the alarm is activated, (e.g., once per day for a period of about one month or more, for a period of about 6 months or more, for a period of about 1 year or more, for a period of about 2 or more years). The number of sounds that may be stored in a subject alarm clock for use as a wake-up signal may range from several, to tens, hundreds, thousands or more. The sound selection played from within a given intensity mode may be the next sequential selection or track. In this way, the unit may cycle through a playlist. Alternatively, the sounds may be selected at random. The random feature may play any sound, or it may be configured to avoid repetition of ones played recently or until all other sounds are played. It may be desirable that the default setting for the clock is random with regard to sound selection from a given intensity category.

The sounds that make-up a sound library may differ by intensity or type. In other words, the subject alarm clocks may include a plurality of sound intensity modes—including a random setting for selection between the varioius sound intensity modes or for any sound in the library or catalogue of sounds. The particular sound mode desired (including a fully random mode selecting any sound stored within the clock), for a given wake-up protocol may be designatable by the user, (e.g., by way of a knob, switch, button, dial, user-interactive display, or the like) of the alarm clock, as described in greater detail below.

Each sound mode within the sound library may include one or more sounds of the selected/given sound intensity, type or genre. User designation of particular intensity mode causes a sound within that group or intensity mode to be emitted from the alarm clock when the alarm is triggered. Once a particular intensity mode is designated, the alarm clock is adapted to emit a sound from the designated type. To reiterate the above, the particular sound may be randomly selected from the set of sounds of the designated intensity; alternatively, the sound may be one that comes next in cycling through a list or cue.

Embodiments include at least a first sound intensity mode and a second sound intensity mode, and may also include a random mode for random selection from the at least first and second sound modes. For example, the sound library may include a first set of sounds of a first sound intensity and a second set of sounds of a second sound intensity. Certain embodiments include at least a first sound mode, a second sound mode and a third sound mode (or four or more), and may also include a random mode (in which its designation provides or plays a sound from any of the stored library of sounds).

The sound intensities used may be any suitable sound intensities, with the requirement being that the intensities differ amongst the different designated intensities. For example, if two sound intensity modes are included, the sound intensity of the sounds of the first mode will differ substantially (albeit maybe only in a subjective or relative fashion) from the sound intensity of the sounds of the second mode. If three sound intensity modes are included, the intensities of the sounds of each mode will differ substantially from the sound intensities of the sounds of the other modes.

In certain embodiments, the sound intensities may be chosen from commonly accepted sound intensities, ranging from soothing sounds to severe sounds. In a system incorporating at least first, second and third sound intensity modes, the first may be a soothing sound intensity mode, the second a “standard” alarm sound intensity mode, and the third mode may be a severe sound intensity mode. Other groupings of sounds may include funny (e.g., comedic excerpt or cartoon soundtrack effect), painful (e.g., nails on a chalkboard), scary or spooky (e.g., sounds commonly associated with Halloween like ghosts moaning, wolf howling, bat wings flapping), disgusting (e.g., flatulence, vomiting, nose blowing) or other genre.

Regarding a “soothing” sound intensity, it is one including such associated sounds as a distant fog horn, gentle ocean waves, seagulls, light wind, running water, rustling trees, bacon sizzling, and the like. A “severe” sound intensity is one including such sounds as charging elephants, garbage truck unloading trash, New York city traffic, train crossing gates, train passage or horn, and the like. A “standard” or intermediate sound intensity falls between the extremes and may even include variations on the same sounds (though possibly altered in volume or magnitude (e.g., smaller vs. crashing waves, gusting or howling wind vs. a light breeze, etc.).

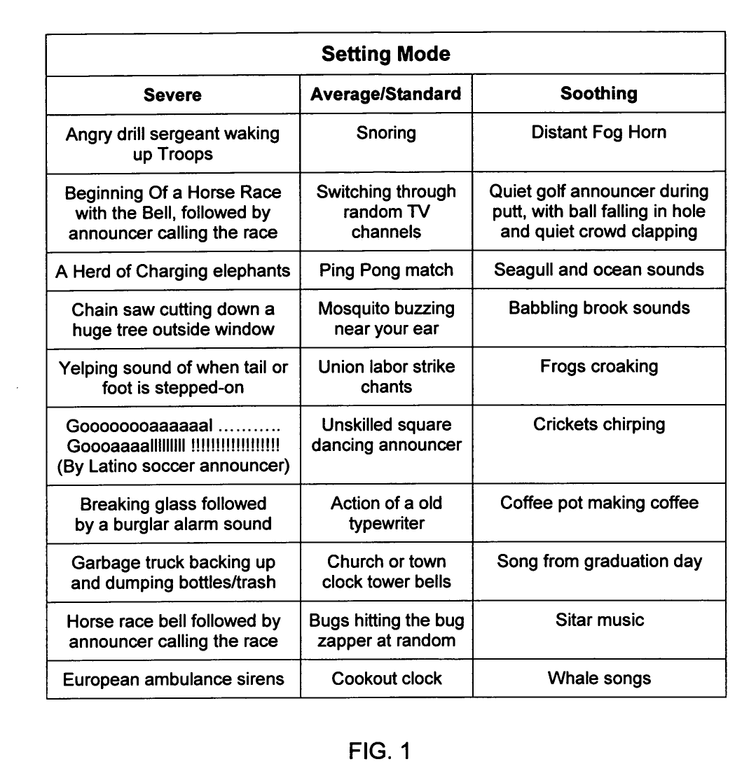

For the purpose of further definition, Table 1 of FIG. 1 provides additional exemplary sounds that may be included as standard/intermediate, soothing and severe sound intensities. Note, however, that another device according to the invention could use many of the same sounds and group them somewhat differently based on user preference, feedback studies, etc. and still fall within the intended scope.

In another aspect of the invention, multiple or serial alarms may be provided as in the “primed” mode of alarm use described above. In one variation, the alarm clock may be programmed to trigger successive alarms at the next higher intensity mode setting (e.g., from soothing to standard, standard to severe, or the like). In another variation, upon occurrence of a predetermined event such as use of a “snooze” button (i.e., alarm repeat/delay activation feature) more than a predetermined number of times (e.g., about 2, 3, 4, 5 or more times in certain embodiments), or if the alarm sounds continuously for a predetermined amount of time (e.g., about 2, 5, 10 or 20 minutes in certain embodiments), then the intensity may be ratcheted upward.

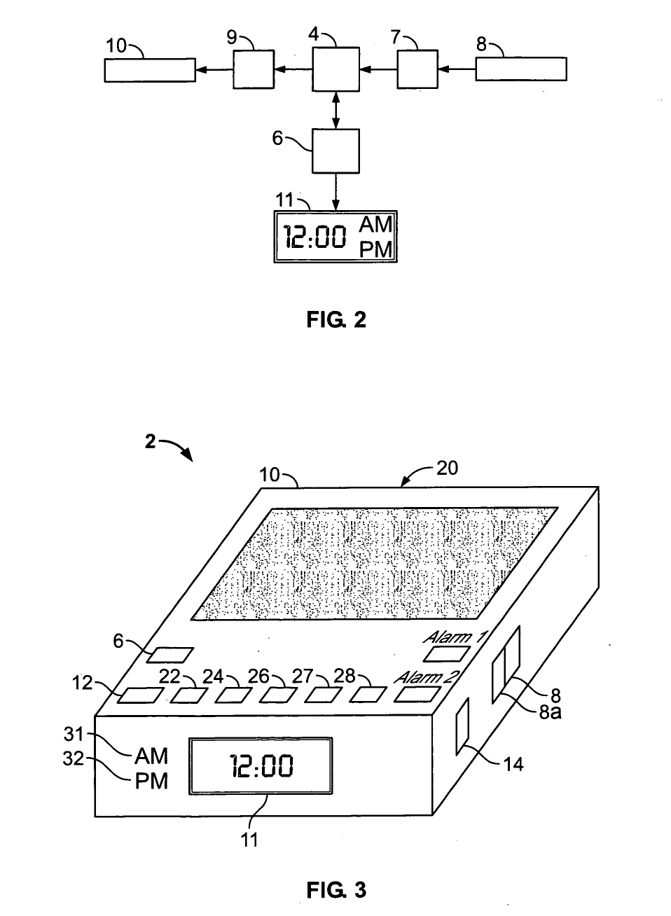

Referring now to the block diagram of FIG. 2, an exemplary hardware implementation of the subject system is shown. Here, the wake-up sounds of the sound library are stored in wake-up sound memory 4. Memory device 4 may be any device capable of storing audio content, and may be removable or non-removable media, and include volatile or non volatile memory devices. In many embodiments, memory 4 is non-removable memory. Memory devices that may be used include, but are not limited to, read-only memory (ROM), random access memory (RAM), static random access memory (SRAM), dynamic random access memory (DRAM), PCMCIA standard compatible plug-in memory card, FLASH card for accepting recordings over a modem which may be included as part of the alarm clock circuit or may be external to the circuit of the present invention, floppy disk, hard disk, DVD, tape, flash memory, a memory stick, and the like. For example, an alarm clock may include a ROM device containing instructions and programs and a RAM device for storing sound in digital form.

Wake-up sound memory device 4 may include a plurality of memory locations and each location may store audio content of a particular sound intensity. For example, a memory device may include a first memory region for storing first intensity mode sounds (e.g., standard wake-up mode sounds), a second memory region for storing second intensity mode sounds (e.g., soothing wake-up mode sounds), and a third location for storing third intensity mode sounds (e.g., severe wake-up mode sounds). No such organization is, however, required. Any approach to addressing the stored data for access and replay will suffice. Still, a more organized data structure may be desirable for the sake of programming and/or upgrading or adding sounds to the repertoire or library of the device.

In any case, the subject alarm clock also includes a controller or processor 6 that can access memory 4 and control the functions of the alarm clock (e.g., drive a display 11 for displaying time, etc.). A “processor” references any combination of hardware or software which can control components as required to execute recited steps and includes, for example, a general purpose digital microprocessor suitably programmed (e.g., from a computer readable medium carrying necessary program code or by communication from a remote location) to perform all of the steps required of it, or any hardware or software combination which will perform those or equivalent steps.

The programming may be provided remotely to processor 6, or previously saved in a computer program product such as memory 4 or some other portable or fixed computer readable storage medium. Such media include, but are not limited to: magnetic storage media, such as floppy discs, hard disc storage medium, and magnetic tape; optical storage media such as CD-ROMs and DVDs; electrical storage media such as RAM, ROM and EPROM; and hybrids of these categories such as magnetic/optical storage media. Program-containing computer-readable medium may be read locally or from a remote location through a communication channel (not shown).

Indeed, the present invention can be run on a general-purpose computer. In which case, the product to be purchased by the user may be software package—boxed or downloaded. Still, a preferred embodiment is one in which the “clock” is a stand-alone unit, that a user can purchase on-line or at any retail outlet.

Variations of the inveniton include alarm clocks that are programmable for two or more independent wake-up protocols. In other words, an alarm clock maybe adapted to store a plurality of preset wake-up protocols, e.g., thereby obviating the need to reset the alarm for varying wake-up schedules. Such may be based on time of day, day of week, etc. The presets may be user-programmed or pre-programmed and associated with a series of buttons for ease of user access.

In certain embodiments, the sound library of a subject alarm clock may be modifiable (e.g., periodically updated or changed). Embodiments that are adapted to enable editing of the sound library increase the customization and personalization of an alarm clock. The sound library may be personalized in a number of ways. The sound library may be personalized by adding to the library recorded speech or familiar sounds. For example, familiar speech such as a spouse's voice may be recorded as a wake-up sound (e.g., a husband or wife screaming “Wake up!”, and the like), a baby's cry may be may be recorded as a wake-up sound, etc.

Accordingly, an aspect of the invention may include audio acquisition 8 (i.e., audio input) so that the user may add wake-up sounds to the sound library from an external sound source. Sounds may be added to the sound library by/from (but not limited to), e.g., computer download, internet download, voice input, keypad input, radio frequency download, wireless application protocol download, MP3 player, radio, television, home theater system, telephone, and the like.

In certain embodiments, audio content may be downloaded from an external source such as via WIFI. The external source may be a specific website, e.g., a subscription music service website. For example, a user may subscribe to a web-based service that permits the download of audio content for a fee. The alarm clock may include a download button or the like and audio content may be downloaded to the alarm clock by activation button of the alarm clock to download audio content from the website, e.g., via WIFI.

Wake-up sounds acquired from an external source and stored in wake-up sound memory device 4 will typically be identified or designated as a particular sound intensity (i.e., are stored in memory 4 as one of the sound intensity modes of the alarm clock). Designation of a particular sound as a member of a set of a particular sound intensity may cause the sound to be stored in a certain location of a memory device or otherwise designated as the particular intensity. A user may designate a sound as a particular sound intensity by any suitable means (e.g., optional keyboard connected to the alarm clock or optional alphanumeric pad integrated with the alarm clock, or, as shown in alarm clock 2 of FIG. 3 optional selector 12 such as a dial, toggle, button, display, etc.,) of the alarm clock.

In certain embodiments, the audio input 8 is built into or otherwise integrated with the alarm clock. An alarm clock may include a built-in microphone used to record a new audio wake-up segment from a sound source and store the recorded sound in memory 4, and/or may include an audio input jack for a monaural or stereo signal. Still further, a user may download or create the sound in a computer and transmit the audio to the alarm clock, e.g., through a connection cable. As such, input 8 may comprise a USB port or other typical digital interface means.

Audio input 8 may include a microphone and associated analog-to-digital (A/D) and digital signal processing (DSP) circuitry 7 (alternatively processor 6 may provide the DSP function) to capture an analog audio signal. The processor may then store the digitized speech in wake-up sound memory 4, as described herein. Thus, in accordance with an embodiment of the present invention, sound signals representative of the desired sound segments may be received by the microphone, converted into digital signals by an A/D converter, and processed and stored in memory under the direction of a digital signal processor. In this manner, the stored sound segments may be used to wake-up a user in a distinctive, personalized way.

As part of the audio acquisition system, an alarm clock may include a visual indicator 8a such as an LED, LCD or the like to indicate audio acquisition. The indicator may also be adapted to notify the user of recording time remaining (such as by blinking) when a predetermined amount of record time remains.

The subject alarm clocks also include audio output 10. Audio output 10 may include an amplifier, speaker, digital-to-analog (D/A) converter and DSP circuitry 9 (alternatively DSP circuitry may be provided by processor 6) to receive digitized audio content from processor 6 and memory 4, convert the digitized audio content to an analog audio wake-up signal, amplify, and broadcast the analog audio wake-up signal through the speaker at the pre-set wake-up time. Audio output 10 may include one or more speakers for playing the intensity-specific alarm sound and may be associated with the alarm clock in any suitable manner. For example, one or more speakers may be connected to the alarm clock by one of a direct, wired connection to a speaker, a wireless radio connection to a speaker, a wireless infrared connection to a speaker, and a means of transmitting data to a speaker that includes transmitting data in a wireless manner. In certain embodiments, the one or more speakers are integrated into the alarm clock, as shown in FIG. 3.

Audio output 10 may include a volume control switch 14 for manually setting volume. Use of this control may further compound the effect of recording level for the various sounds output from the device. Furthermore, audio output 10 may include an automatic volume control to automatically increase the volume of the analog audio signal during wake-up, from an initial volume to a maximum volume level, over a predetermined time period to provide crescendo to certain wake-up tones. Such automated volume control could also be employed in repeating one type of sound as successively higher levels to vary its intensity. An example of a sound that could be soothing at low levels is a “distant” fog horn. At a higher level, it offers and intermediate level of wake-up alarm. Blaring at maximum speaker intensity, the fog horn could be regarded as an intense wake-up signal.

In certain embodiments, the functions of the A/D, DSP and D/A circuitry may be provided on a single chip or device, such as (but not limited to), for example, an ISD2532 Single Chip Voice Record/Playback Device (manufactured by Winbond Electronics Corp. of San Jose, Calif.) or analogous device. In such embodiments, audio input 8 may include a microphone and the single-chip voice record/playback device, which may include on-chip audio memory to store the digitized audio content, while audio output may include the speaker and associated amplification circuitry, which may include volume control, as noted above. The audio acquisition process may be activated by a control switch, and the analog sound signal may be input to the single-chip voice record/playback device via the microphone, converted to digitized speech and then stored in on-chip memory (e.g., a particular sound intensity).

In certain embodiments, speakers of the alarm clock may be used with external audio sources so that audio from the external source may be played through the alarm clock speakers (e.g., even when not used for wake-up). For example, a communication link, e.g., an input jack, may be adapted for cable connection to a conventional radio, home theater, DVD, MP3 player, computer, etc., allowing the audio from such external sources to be amplified by the speakers of the alarm clock.

Alarm clocks of the subject invention may include various optional features such as multiple alarm protocols, snooze, etc., whereas such features are well-known in the art to which the invention pertains.

Alarm clocks according to the present invention may be adapted to store a plurality of independent wake-up protocols or events (see for example alarm programs 1 . . . N of display 12 b of FIG. 6) and may be adapted to store weekly wake-up protocols, monthly protocols, yearly protocols, etc. In other words, an alarm clock may be programmed for a wake-up schedule for an entire week, month, year, etc., such that the wake-up schedule includes a plurality of wake-up protocols that differ in at least one parameter (date, time, wake-up intensity, etc.).

The different wake-up protocols may be selectively activated by the user, for example on a weekday the user may simply activate the weekday schedule or schedule for a particular day of the week, or the alarm may be programmed to automatically run the stored alarm protocols at the appropriate time (as the appropriate date/time occurs). The protocols may be selectively deactivateable so that, (e.g., a first programmed alarm protocol may be deactivated for a particular week if a schedule requires temporary deactivation) without deactivating any other programmed alarm protocols. The user may be on vacation and not require the effective wake-up offering of the present invention. Setting an alarm clock for various wake-up schedules may be accomplished in any suitable manner, e.g., by way of one or more selectors of the alarm clock.

The subject alarm clocks are adapted to enable different wake-up intensities for different, independent wake-up protocols programmed into the alarm clock. For example, a subject alarm clock may be programmed for a first alarm protocol of first intensity and a second alarm protocol of second intensity.

In certain embodiments, a single alarm clock may be programmed to accommodate wake-up protocols for two or more persons (i.e., an alarm clock may be programmed for a first wake-up protocol (time/wake-up intensity, and the like) for a first person and a different, second wake-up protocol for a second person). An alarm may be programmed for two or more wake-up protocols based on the days of the week. An alarm may be programmed for a first wake-up protocol for certain days of the week (e.g., weekdays) and a second wake-up protocol for certain other days of the week (e.g., weekend days). The alarm intensities of the first and second wake-up protocols may differ (i.e., the first alarm protocol (weekday wake-up protocol) may be of a first alarm intensity, such as for example severe intensity mode, and the second alarm protocol (weekend protocol) may be of a second alarm intensity, such as for example soothing alarm intensity).

Other configurations are possible as well. For example, an alarm clock may be preset for a daily, weekly, monthly, etc., wake-up protocol that accounts for the day/time of street cleaning, parking regulations, etc. Seven (one for each day of the week) individual alarm protocols may be preset so that a weekly schedule need only be programmed one time.

It is known that a user may set the time of the clock ahead by a known amount in an attempt to deceive themselves when the alarm is triggered into thinking that the time is actually later than it really is. However, this technique is often ineffective because the person knows exactly how much time has been added to the clock. By a simple math computation when the alarm is triggered, the actual time may be quickly determined.

Using the microprocessor of the present invention, however, the alarm clock may include a “time warp” feature that belies user avoidance. In certain embodiments, a time warp may occur from about 30 to about 20 minutes before the alarm is triggered and continue until a predetermined time after the alarm is triggered or until the alarm is turned-off by the user—at which time the time is returned to actual time. For example, time warp may occur from about 1 minute to about 15 minutes before the alarm is triggered (e.g., from about 5 minutes before the alarm is triggered to about 10 minutes before the alarm is triggered).

The time warp may continue through the alarm signal and for a period of time after the alarm is triggered (in certain embodiments regardless of whether the alarm is turned-off by the user or not). For example, time warp may continue from about 30 seconds to about 20 minutes after the alarm is triggered (e.g., from about 1 minute to about 15 minutes after the alarm is triggered). By such continuation, the user is not able to avoid the imperative of the alarm by waiting for the actual time to display and then return to sleep.

The time warp may change on a periodic or random basis so that the time may be modulated by different amounts for different wake-up events. The warp may be set such that it may go to +/−about 5 min. 10 min, 15, min., etc. In other words, the clock processor may include a plus and/or minus time warp in that the time (real or current time) may be randomly modulated by addition or subtraction of time. Yet, it will remain basically centered about the actual time. Accordingly, it offers a time-piece that one can employ (if set conservatively) to meet the tasks of the day. For such a purpose, it may also be desirable that when employing time warp features that the actual real time may be shown. It may appear automatically after a prescribed time, or it could be accessed by a user depressing an override or “real time” button (not shown).

As referenced above, the subject alarm clocks may include a snooze feature, to temporarily silence the wake-up signal for a predetermined time period. This feature may too be variable (i.e., set by a user to a desired time interval) and/or randomizable in a manner similar to the time warp so that it may offer any amount of time between (e.g., 5 and 15 min.) or some user-set interval. The snooze mode may be activated in any suitable manner, e.g., snooze activator 16. In certain embodiments, the snooze function may be activated by voice command. Certain alarm clocks may limit the total time that the wake-up signal will be played to a specific period, such as one hour or the like, to prevent the signal from sounding continuously if the user is unable to terminate the wake-up signal. Or, as described above, after a prescribed—or even randomized—amount of time, the intensity of the alarm setting or alarm type may be edged or jump upwards.

The alarm clocks of the subject invention may be powered by any suitable power source (not shown). The power supply may provide AC power or DC power, at the appropriate voltages and currents, to the various components of an alarm clock. In certain embodiments, the power supply may include a rechargeable, or non-rechargeable, battery, voltage regulator, power control circuitry, power switch, etc., to provide one or more supply voltages, such as, for example, 9V, 5V, etc. For example, the power supply may operate on 120V AC power only, DC power only, a combination of AC and rechargeable, or non-rechargeable, DC power, etc. The DC power may provide a back-up against power outages. Alternatively, by running on DC by being switchable between AC and DC power, the clock may be suitable for use as a travel alarm clock (in addition to home use, if so-desired). Still further, a subject alarm clock may be adapted to utilize AC power via connection to a standard household electrical outlet, and also utilize a re-chargeable battery which re-charges when connected to the electrical outlet.

The alarm clock of FIG. 3 shows various other features that may be included in the subject alarm clocks. Shown are time display 11 (e.g., LCD or LED display) for displaying the current time, wake-up intensity mode selector 12, alarm on/off 22, alarm time set 24, actual time set 26, hour set selector 27, minute set selector 28. AM/PM indicator(s) 31 and 32 are also provided. In certain embodiments, the AM/PM indicators are “AM” and “PM” lighted letters, e.g., LED or LCD AM/PM displays. In sum, the clock may employ a custom or any typical enclosure, power management options and/or display means.

Of greater interest, the alarm clocks include a wake-up intensity mode selector 12. Wake-up intensity mode selector 12 may be in any suitable form including, but not limited, such a rotatable dial, a sliding scale, an alphanumeric input control (e.g., allowing the user to type in a number, letter, or word), buttons, A manual switch is shown, a touch-panel type LCD, etc.

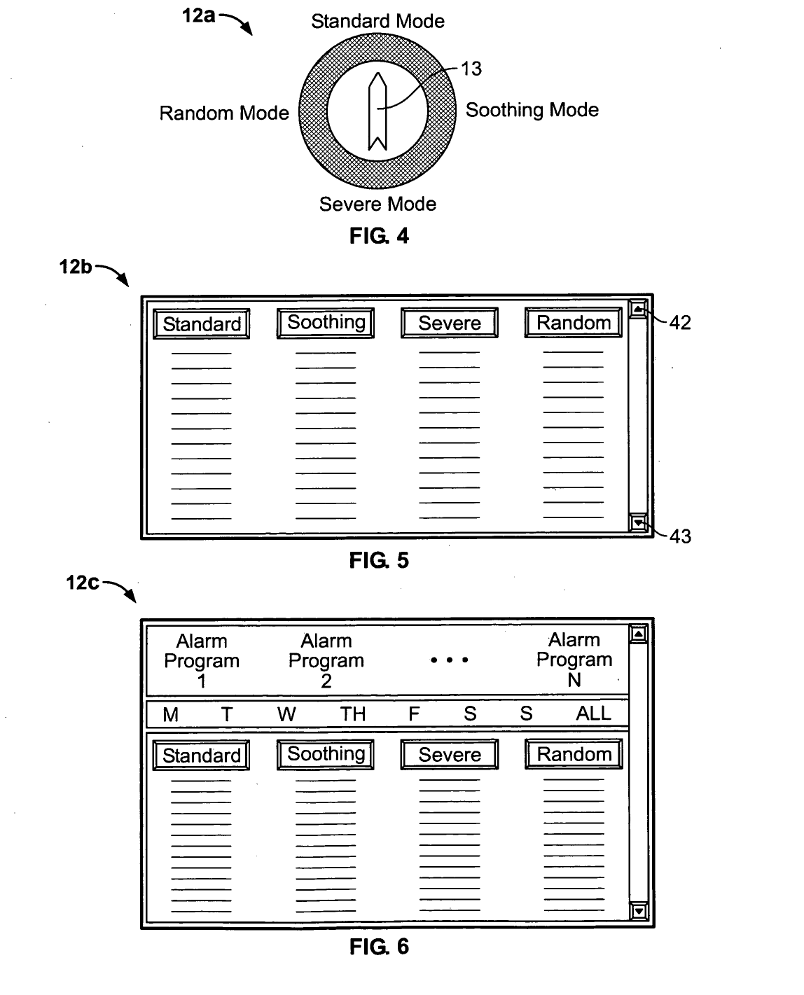

FIG. 4 shows an exemplary embodiment of a dial 12a that may be used to select a desired intensity mode. Dial 12a is rotatable so that pointer 13 points to the desired intensity mode. It may point to any of the aforementioned modes, including a random mode as shown. Intensity mode selector may also be a digital display adapted to display characters or graphics at least corresponding to the available sound intensity modes of the invention and optional random mode. The display may include one or more screens of alarm clock content.

FIG. 5 shows an exemplary embodiment of digital display 12b. In this embodiment, display 12b also displays the individual sounds that fall within each intensity mode. Display 12b also includes navigation graphics 42 and 43 in the form of arrows that may be utilized for navigating or scrolling of information displayed on display 12b. Display 12b may be adapted to allow a user to designate an intensity mode displayed on the screen. For example, display 12b may be provided with a touch screen interface that allows a user to select displayed content. An input device, including, but not limited to, a stylus (not shown) may be used to interact with display 12b.

A digital display may additionally be adapted to display a variety of alarm clock information and functions such as, but not limited to, battery indicator, volume indicator, available memory size, etc. In certain embodiments, a display may be adapted for user selection of a variety of alarm parameters. For example, some or all of the wake-up time parameters of a wake-up protocol may be selected from the display, (e.g., by way of a touch screen as described above).

FIG. 6 shows display 12c that includes user selectable features for setting various parameters of a wake-up protocol. In such embodiments, the display may include icons, characters or the like that correspond to the different alarm protocol parameters such as the selection of a first alarm protocol, second alarm protocol . . . N alarm protocol, and the various parameters of that particular alarm protocol such as the day(s) of the week, wake-up time, intensity mode, etc. Content may be shown on one screen as shown in FIG. 6 or multiple screens navigatable by the user.

Using a subject alarm clock generally includes, in any order, setting a wake-up time in the alarm clock to activate the wake-up signal when the set time matches a current time, and designating a particular intensity mode. As described above, the intensity mode may be designated from a plurality of intensity modes, including random mode, e.g., standard mode, soothing mode, severe mode and random mode.

An aspect of the invention includes setting at least two different wake-up protocols wherein the designated wake-up intensities of the protocols may differ. For example, such embodiments may include, in any order, setting a first wake-up time in the alarm clock to activate the wake-up signal when the set time matches a current time, and designating a particular intensity mode for the first wake-up protocol; and setting a second wake-up time in the alarm clock to activate the wake-up signal when the set time matches a current time, and designating a particular intensity mode for the second wake-up protocol. Another aspect of the invention includes editing a sound library of an alarm clock, (e.g., by adding and/or deleting sounds from the sound library, and assigning the newly added sounds a sound intensity identifier). The sound library may be edited by any suitable method, e.g., connection cable, wireless connection (e.g., WIFI, and the like), etc. Methods may also include connecting an external device such as an MP3 player, computer, stereo, CD player, etc., to a subject alarm clock (e.g., via an input jack or the like) and listening to audio from the external source using the audio output of the alarm clock.

Variations

Exemplary aspects of the invention, together with details regarding material selection and manufacture have been set forth above. As for other details of the present invention, these may be appreciated in connection with the above-referenced patents and publications as well as generally know or appreciated by those with skill in the art.

The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Stated otherwise, except as specifically defined herein, all technical and scientific terms used herein are to be given as broad a commonly understood meaning as possible while maintaining claim validity.

### CLAIMS

The breadth of the present invention is not to be limited to the examples provided and/or the subject specification, but rather only by the scope of the claim language. That being said, we claim:

1. An alarm clock comprising:
a memory device comprising a plurality of sounds of different intensity groups stored in the memory device; and
a processor coupled with the memory and adapted to read from the memory and to cause an a sound from a user-selected intensity to play as an alarm at a designated time.

2. The alarm clock of claim 1, wherein first, second and third intensity sound groups are provided, the groups corresponding to soothing, standard and severe intensity sounds, respectively.

3. The alarm clock of claim 1, comprising a selector for user selection of a particular sound intensity mode for alarm output.

4. The alarm clock of claim 3, wherein the selector includes a random mode for selection of any of the intensity modes.

5. The alarm clock of claim 1, wherein sounds selected for output from the selected intensity are played at random.

6. The alarm clock of claim 1, wherein sounds selected for output from the selected intensity are played in sequence.

7. The alarm clock of claim 1, wherein the alarm clock further comprises an input for sound storage in the memory device.

8. The alarm clock of claim 7, wherein the audio input comprises a recorder.

9. The alarm clock of claim 1, wherein the audio input is adapted for transferring sound from one or more external devices to the memory device.

10. The alarm clock of claim 9, wherein the one or more external devices comprises a CD player, telephone, audio recorder, MP3 player, television, stereo, website and a computer.

11. The alarm clock of claim 1, wherein the alarm clock is programmable for a first wake-up protocol and a second wake-up protocol.

12. The alarm clock of claim 11, wherein the first and second wake-up protocols are based on at least one of time of day and day of week.

13. The alarm clock of claim 11, wherein the intensities of the first and second wake-up protocols differ.

14. The alarm clock of claim 1, wherein the memory is non-removable memory.

15. The alarm clock of claim 1, further comprising a time-warp feature providing for offsetting at least alarm sound output from a time designated by a user.

16. A method of setting an alarm clock to activate a wake-up sound, the method comprising:
setting a wake-up time in the alarm clock to activate a wake-up alarm of a user-designated sound intensity when the set time matches a current time; and
designating a particular intensity setting, apart from setting volume, for the wake-up alarm.

17. The method of claim 16, wherein the methods comprises designating a sound intensity from a first intensity, second intensity, third intensity and random intensity.

18. The method of claim 17, wherein the first intensity is soothing intensity, second intensity is standard intensity and third intensity is severe intensity.

19. The method of claim 16, wherein the wake-up sounds are stored in memory of the alarm clock and the method further comprising editing the stored wake-up sounds of the alarm clock.

20. A computer readable medium having programming stored thereon for operating an alarm clock allowing user-selection according to claim 16.
